(19) United States
(12) Patent Application Publication
(10) Pub. No.: US 2026/0239239 A1
(43) Pub. Date: Aug. 13, 2026

(54) METHODS OF HANDLING TIME ACCURACY AND SYNCHRONIZATION STATUS REPORTING AND SERVICE

(71) Applicant: Telefonaktiebolaget LM Ericsson (publ), Stockholm (SE)

(72) Inventors: Aleksejs UDALCOVS, Stockholm (SE); Nianshan SHI, Järfälla (SE)

(73) Assignee: Telefonaktiebolaget LM Ericsson (publ), Stockholm (SE)

(21) Appl. No.: 19/155,953

(22) PCT Filed: Feb. 15, 2024
(86) PCT No.: PCT/IB2024/051446

§ 371 Date: Aug. 13, 2025

Related U.S. Application Data
(60) Provisional application No. 63/446,143, filed on Feb. 16, 2023.

(51) Int. Cl. H04W 56/00; H04W 36/08

(52) U.S. Cl. CPC H04W 56/001; H04W 36/08

(57) ABSTRACT

Methods, core network functions and radio access network node are provided wherein the Radio Access Network node obtains Time Accuracy/Synchronization Status reporting configuration from a first core network function of a core network, and sending Time Accuracy/Synchronization status reports to the first core network function in accordance with the TASSR configuration and wherein the Time Accuracy/Synchronization Status reports include one or more of time accuracy and time synchronization status. The TASSR configuration may be triggered by a request from a second core network function.

### RELATED APPLICATIONS

This application claims the benefit of provisional patent application Ser. No. 63/446,143, filed on Feb. 16, 2023, the disclosure of which is hereby incorporated herein by reference in its entirety.

### BACKGROUND

In 3GPP TR 23.700-25, the “Study on timing resiliency and TSC and URLLC enhancements” (Release 18), it has been agreed that a User Equipment (UE) with the corresponding subscription may get informed about the timing synchronization status change. Within the study, among other aspects, an agreement was reached on how a time synchronization status information can be reported to UEs, as stated 3GPP S2-2301421 incorporated by reference:

“The support for network timing synchronization status monitoring enables the 5GS to modify time synchronization service for a UE or a group of UEs depending on the current synchronization status and notify service updates. There may be three consumers of this information:
TSCTSF may receive node-level information about timing synchronization status from NG-RAN and/or UPF/NW-TT directly from OAM or alternatively, if supported by a node, using control plane signaling at node level. Node level signaling uses UMIC for UPF/NW-TT case and an AMF service to report N2 node level information for NG-RAN case.
AF may subscribe to time synchronization status notifications for a UE or group of UEs for which the AF requests or has requested time synchronization service (for 5G access stratum time distribution or (g) PTP services).
For 5G access stratum time synchronization service, the UE may receive clock quality information from the NG-RAN based on UE subscription data stored in the UDM (see clause 5.27.1.11 of the TR 23.700-25 enclosed herein by reference) or AF request for clock quality reporting to the UE.

A prerequisite for this feature is that NG-RAN and UPF can detect and report timing synchronization degradation or improvement events locally. However, the exact details on how this detection is done is outside 3GPP scope and will not be discussed:
“While the time synchronization service is offered by the 5GS, based on 5G access stratum-based time distribution or (g) PTP-based time distribution, the network timing synchronization status of the nodes involved in the operation (e.g., NG-RAN nodes and/or UPF/NW-TTs) may change. NG-RAN and UPF/NW-TT can detect timing synchronization degradation or improvement locally.”

However, it is required (for this feature to work) that NG-RAN reports a node-level information about it's time synchronization status to a core network (CN), Time Sensitive Communications and Time Synchronization Function (TSCTSF) in particular so that the TSCTSF is able to identify impacted services and UEs impacted by a time synchronization status degradation/failure/improvement event. However, it remains unclear which parameters NG-RAN may use when it reports/describe the current time synchronization information as it required RAN WGs feedback, see in 3GPP S2-2301421:
“RAN nodes may be pre-configured with the thresholds for each attribute, if supported, that is described in Table 5.27.1.X-1. When the network timing synchronization status exceeds the threshold (i.e., status degradation), or the network timing synchronization status meets the thresholds again (i.e., status improvement), the RAN node notifies the TSCTSF with the RAN Node ID and the corresponding network timing synchronization status attributes as described in this clause.

TABLE 5.27.1.X-1
Information elements contained in NG-RAN or UPF timing
synchronization status information [NOTE 1]

| Information Name | Description | Category |
|---|---|---|
| Synchronization | Indicates the state of the node | Optional |
| state | synchronization, represented | |
| | by the values “Locked”, | |
| | “Holdover”, or “Freerun” | |
| | (NOTE 1). | |
| Synchronization | Traceable to UTC | Optional |
| performance | Traceable to GNSS | |
| | Frequency stability | |
| Clock quality | clock accuracy | Optional |
| Time source | Describes the primary source | Optional |
| | the node is currently using, | |
| | represented by the values | |
| | “SyncE”, “PTP”, “GNSS”, | |
| | “atomic clock”, “terrestrial | |
| | radio”, “serial time code”, | |
| | “NTP”, “hand set”, “other”. | |

Editor's Note:
Information elements contained in NG-RAN depends on RAN capabilities to determine them and pending RAN WGs feedback.
NOTE 2:
Clock is in the “Locked”, “Holdover”, or “Freerun” mode, as defined in ITU-T G.810 [X].
”

Here, we emphasize that not all time synchronization status characterizing elements are available or can even be estimated/obtained at NG-RAN nodes. Next, it's important to emphasize that level of information that may be provided to UEs can be different and depends on UE's subscription. If a UE has the subscription to time synchronizations services (e.g., Access Stratum-based Time Synchronization (ASTI)) and to get informed about changes in time synchronization status, the “Access and Mobility Subscription data” at the UDM includes also “Clock Quality Reporting Control Information” specifying what can be reported to that UE, see in 3GPP S2-2301421 replicated below:
“For 5G access stratum time synchronization service, clock quality reporting control information manages the NG-RAN timing synchronization status notifications to the UE. When AMF provides the 5G access stratum time distribution indication and the Uu time synchronization error budget to NG-RAN, AMF also includes the clock quality reporting control information provided by the TSCTSF or received from UDM. Clock quality reporting control information may be present in the AF request or Access and Mobility Subscription data at the UDM, and contains the following fields:
   Clock quality detail level. It indicates whether and which clock quality information to provide to the UE and can take one of the following values: clock quality metrics or acceptable/not acceptable indication.
   If the clock quality detail level equals “clock quality metrics”, the NG-RAN provides clock quality metrics to the UE that reflect its current timing synchronization status. Clock quality metrics refers to the following information: clock accuracy, traceability to UTC and to GNSS, frequency stability, parent time source, synchronization state.
   If the clock quality detail level equals “acceptable/not acceptable indication”, clock quality acceptance criteria for the UE. The NG-RAN provides an acceptable indication to the UE if the NG-RAN's timing synchronization status matches the acceptance criteria received from AMF; otherwise, NG-RAN indicates “not acceptable” to the UE. Acceptance criteria can be defined based on one or more of the following attributes: parent time source, traceability to UTC and to GNSS, synchronization state, clock accuracy, frequency stability.
Editor's Note: Attributes that can be used for clock quality acceptance criteria depends on RAN capabilities to determine them and pending RAN WGs feedback.”
Here, it important to highlight two aspects:
   1) clock quality reporting control information manages the NG-RAN timing synchronization status notifications to the UE;
   2) attributes that can be used for clock quality acceptance criteria depends on RAN capabilities.

Finally, it is worth noting that this feature does not apply for 3GPPpre-Rel18 UEs, i.e., to ensure the backward compatibility with Rel-17 UEs, time synchronization status report can be sent to a UE only when the UE has a corresponding subscription, and the subscription data contains “Clock Quality Reporting Control Information”. “Clock Quality Reporting Control Information” may also be provided by an AF, if the AF is a requester of an ASTI service. In any case, which clock quality information to be provided to UEs depends on the needs of the time service consumer and therefore there should be an agreement in place (i.e., SLA) between the 5G network operator and the client network operator, see Note 5 in 3gpp S2-2301461 incorporated herein by reference:
“NOTE 5: Whether and which clock quality information to provide to the UE depends on the needs of the time service consumer (referred to as client network operator hereafter). Therefore, the clock quality detail level and clock quality acceptance criteria are based on the parameters and their values specified in the agreement between the 5G network operator and the client network operator. The clock quality acceptance criteria refer to the quality with which 5G access stratum time needs to be delivered to and received by the UE (i.e. also considering propagation delays). Additional inaccuracies in the UE, e.g. if the 5G access stratum time is delivered to devices attached to the UE, are not included in the clock quality acceptance criteria because they are assumed to be budgeted by the client network operator when agreeing the required clock accuracy with the 5G network operator.”

### SUMMARY

Certain aspects of the present disclosure and their embodiments may provide solutions to the aforementioned or other challenges.

This present disclosure proposes a solution for:
NG-RAN/gNB indicates its support of time synchronization status reporting or how the information about these NG-RAN/gNB capabilities can be reported to a CN;
CN indicates how NG-RAN/gNB should perform Time Accuracy/Synchronization status reporting (TASSR);
NG-RAN/gNB performs TASSR;
UE providing information to a NG-RAN/gNB that it may receive a time synchronization service (ASTI with time sync status reporting in particular) so that NG-RAN/gNB could steer it, or use it during Handover in a later phase;
NG-RAN/gNB makes the decision to serve or to steer away UEs that provide ASTI service(s);
NG-RAN/gNB informs a CN (TSCTSF in particular via AMF) in cases when UEs are served by a NG-RAN/gNB that does not support TASSR so that the AF that requested the service is aware that the feature is not available and therefore its request is rejected or modified by the TSCTSF;
How the TASSR information/capabilities are sent to RRC connected UE and between a source and a target NG-RAN/gNB.

In some embodiments, a method performed by a first core network function providing access and mobility management services is provided. The method includes the step of providing to a radio access network (RAN) node a Time Accuracy/Synchronization Status Reporting configuration to trigger Time Accuracy/synchronization Status Reporting by the RAN node and receiving by the first core network function one or more Time Accuracy/Synchronization Status reports generated by the RAN node based on the Time Accuracy/Synchronization Status Reporting configuration. For example, the first core network function is an Access mobility management function in a 5G system.

In another example the one or more Time Accuracy/Synchronization Status reports include one or more of clock accuracy and synchronization state.

In another aspect, the method comprises the step of when receiving the Time Accuracy/Synchronization Status reports from the RAN node, providing to the RAN node information indicating whether the RAN node can or cannot serve a User Equipment (UE) in accordance with Access Stratum Time Synchronization (ASTI) subscription obtained for the UE which may be obtained or triggered by a request from another core network function. The CN node may alternatively or in addition instruct the RAN node to handover the UE to a target RAN node.

In some aspect, the Time Accuracy/Synchronization Status reports obtained by the first core network function from the RAN node are provided to the second network function.

In some embodiments, a method performed by a second core network function providing time synchronization service (e.g., TSCSF in 5G system) is provided, the method comprising the step of receiving for one or more UEs Time Accuracy/Synchronization Status reporting (TASSR) request or Access Stratum Time Synchronization (ASTI) service request originated from an Application Function (AF) then the steps of receiving from a first core network function (e.g., AMF in 5G system) Time Accuracy/Synchronization Status report generated by a Radio Access Network (RAN) node for the one or more UEs and determining based on the Time Accuracy/Synchronization Status report whether the one or more UEs are served by the RAN node that supports the requested time synchronization status reporting from the AF and the second core network function providing instructions, for example via the first core network function such as AMF in a 5G system to be applied toward the RAN node in accordance with the determination.

In one example, the instructions from the second core network function comprises informing the first network function about a new or modified Clock Quality Detail Level. Alternatively or in addition, the instructions comprise providing for the RAN node information indicating that the RAN node can or cannot serve a User Equipment in accordance with the requested Time Accuracy/Synchronization status reporting or the ASTI service request.

According to some aspect, based on the received Time Accuracy/Synchronization Status report, the second core network function performs the step of including the instruction that a handover to a target RAN node is to be performed from the RAN node that provided the Time Accuracy/Synchronization Status reports for the one or more UEs.

In some embodiments, a method performed by a Radio Access Network (RAN) node is provided. The method includes the step of obtaining Time Accuracy/Synchronization Status reporting configuration from a first core network function of a core network, the step of sending Time Accuracy/Synchronization status reports to the first core network function in accordance with the Time Accuracy/Synchronization Status reporting configuration and wherein the Time Accuracy/Synchronization Status reports include one or more of time accuracy and time synchronization status.

In some embodiment, The method includes the step of receiving instruction to be applied as a result of the provided Time Accuracy/Synchronization Status reports.

For example, the instruction comprises information indicating whether the RAN node can or cannot serve a User Equipment (UE) in accordance with a requested Access Stratum Time Synchronization (ASTI) subscription or a UE subscription.

Alternatively or in addition, the instruction comprises performing a handover to a target RAN node.

In some embodiment, the method further comprises sending to the core network a capability information indicating whether the RAN node is able to perform Time Accuracy/Synchronization Status reporting.

In other aspect, the method further comprises sending to the core network Time Accuracy/Synchronization Status reporting preferences.

In some embodiment, a network node or server and a radio access network node are provided and they are adapted or comprise one or more processors and memory comprising instructions which when executed by the one or more processors perform any of the embodiments described herein.

In some embodiment, a non-transitory computer-readable storage medium is provided and includes executable instructions that when executed by a processor causes the processor to perform any of the embodiments enclosed herein.

### BRIEF DESCRIPTION OF THE DRAWINGS

The accompanying drawing figures incorporated in and forming a part of this specification illustrate several aspects of the present disclosure, and together with the description serve to explain the principles of the present disclosure.

FIG. 1 illustrates one example of a wireless communications system in which embodiments of the present disclosure may be implemented;

FIG. 2 illustrates one example of a core network of a wireless communications system supporting time synchronization in which embodiments of the present disclosure may be implemented;

FIG. 3 illustrates another example of a core network of a wireless communications system illustrating 5G System (5GS) in a service based architecture supporting time synchronization;

FIG. 4A illustrates a procedure for CN procedure based on ASTI service activated by the subscription according to some embodiments;

FIG. 4B illustrates a procedure for CN procedure based on ASTI service activated by AF request according to some embodiments;

FIG. 4C illustrates a procedure for CN procedure based on ASTI service activated by AF request according to some embodiments;

FIG. 4D illustrates the different TASS reporting options according to some embodiments;

FIG. 4E illustrates a procedure for providing time accuracy info to a UE according to some embodiments;

FIG. 4F illustrates a procedure for providing time accuracy info to a UE according to other embodiments;

FIG. 4G illustrates a procedure for handover a UE to a target NG-RAN node for the ASTI service according to some embodiments;

FIG. 5A; illustrates a flow chart for a method performed at an AMF according to some embodiments.

FIG. 5B; illustrates a flow chart for a method performed at a TSCTSF according to some embodiments.

FIG. 6; illustrates a flow chart for a method performed at a NG-RAN node according to some embodiments.

FIGS. 7, 8, and 9 are schematic block diagrams of example embodiments of a network node.

FIGS. 10, 11, and 12 are schematic block diagrams of example embodiments of a NG-RAN node.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Although the embodiments are described using a 5G core network, it will be apparent to a person skilled in the art that any core network that supports edge computing can implement these embodiments, including 4G, 6G and beyond.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), a TSCTSF and an AF or the like.

Communication Device: As used herein, a “communication device” is any type of device that has access to an access network. Some examples of a communication device include, but are not limited to: a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

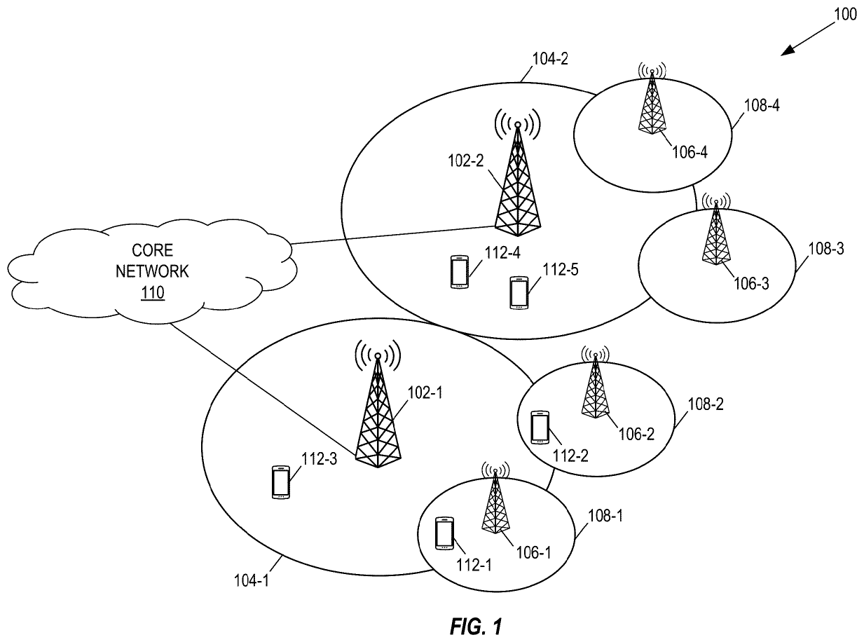

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

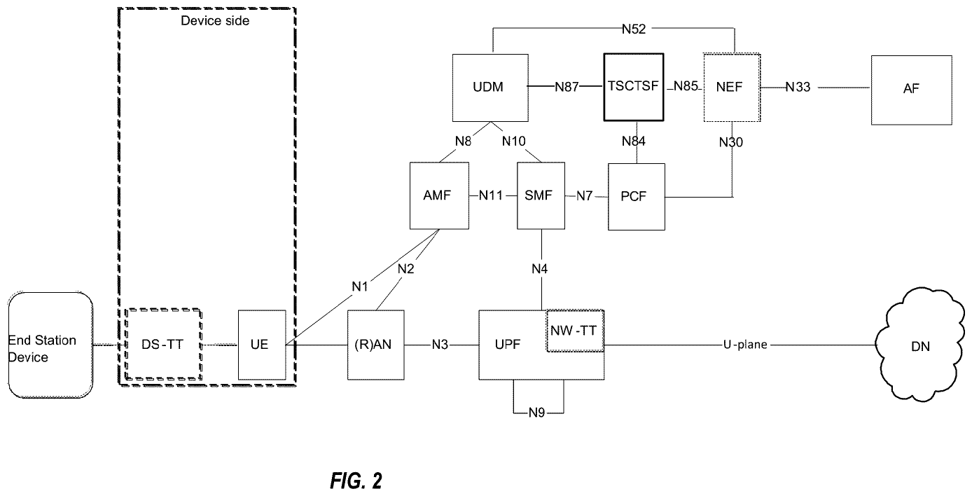

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the cellular communications system 100 of FIG. 1.

A Network Function (NF) may be implemented either as a network element on a dedicated hardware, as a software instance running on a dedicated hardware, or as a virtualized function instantiated on an appropriate platform, e.g., a cloud infrastructure.

Seen from the access side the 5G network architecture shown in FIG. 2 comprises a plurality of UEs 112 connected to either a RAN 102 or an Access Network (AN) as well as an AMF 200. Typically, the R (AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, an Application Function (AF) 212, a NEF and a TSCTSF.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208. FIG. 2 further illustrates a 5G architecture that supports Time Sensitive Communication and Time Synchronization services based on IEEE Std 802.1AS or IEEE Std 1588 for Ethernet or IP type PDU Sessions. The DS-TT, NW-TT and Time Sensitive Communication and Time Synchronization Function (TSCTSF) are required in order to support the features in IEEE Std 802.1AS or IEEE Std 1588. The TSCTSF 216 supports amongst other functionalities associating the time synchronization service request from the NF consumer to the AF sessions with the PCF (the session between the PCF and TSCTSF). TSCTSF 216 controls the DS-TT(s) and NW-TT for the (g) PTP based time synchronization service. In addition, TSCTSF 216 supports TSC assistance container related functionalities. If the AF is considered to be trusted by the operator, the AF could interact directly with TSCTSF 216 over N85 reference point, else it interacts with the TSCTSF 216 via the NEF over the N33 reference point. The connection between AF and TSCTSF 216 is not depicted in the architecture diagram of FIG. 2 for brevity. The NEF exposes 5GS capability to support Time Synchronization service as described in clause 5.27.1.8 of 3GPP TS 23.501.

The 5GC network aims at separating UP and CP. The UP carries user traffic while the CP carries signaling in the network. In FIG. 2, the UPF 214 is in the UP and all other NFs, i.e., the AMF 200, SMF 208, Policy Control Function (PCF) 210, AF 212, Network Slice Selection Function (NSSF) 202, Authentication Server Function (AUSF) 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency. The UPF/NW-TT of FIG. 2 distributes the (g) PTP messages towards the DS-TTs. When the UPF supports one or more NW-TT(s), there is one-to-one association between an NW-TT and the network instance or between an NW-TT and network instance together with DNN/S-NSSAI in the UPF. When there are multiple network instances within a UPF, each network instance is considered logically separate. The network instance for the N6 interface may be indicated by the SMF to the UPF for a given PDU Session during PDU Session establishment procedure. The UPF allocates resources based on the Network Instance and S-NSSAI. The DNN/S-NSSAI may be indicated by the SMF together with the network instance to the UPF for a given PDU Session during PDU Session establishment procedure.

The same NW-TT is used for all PDU Sessions in the UPF for the given DNN/S-NSSAI; the NW-TT is unique per DNN/S-NSSAI. This ensures that the UPF selects an N4 session associated with the correct TSCTSF 216 when the NW-TT initiates a user plane node Management Information Container (UMIC) or a Port Management Information Container (PMIC). Port management information is transferred transparently via 5GS between TSN AF or TSCTSF 216 and DS-TT or NW-TT, respectively, inside PMIC. User plane node management information is transferred transparently via 5GS between TSN AF or TSCTSF 216 and NW-TT inside a UMIC. At any given time, the NW-TT is associated with a single TSCTSF.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

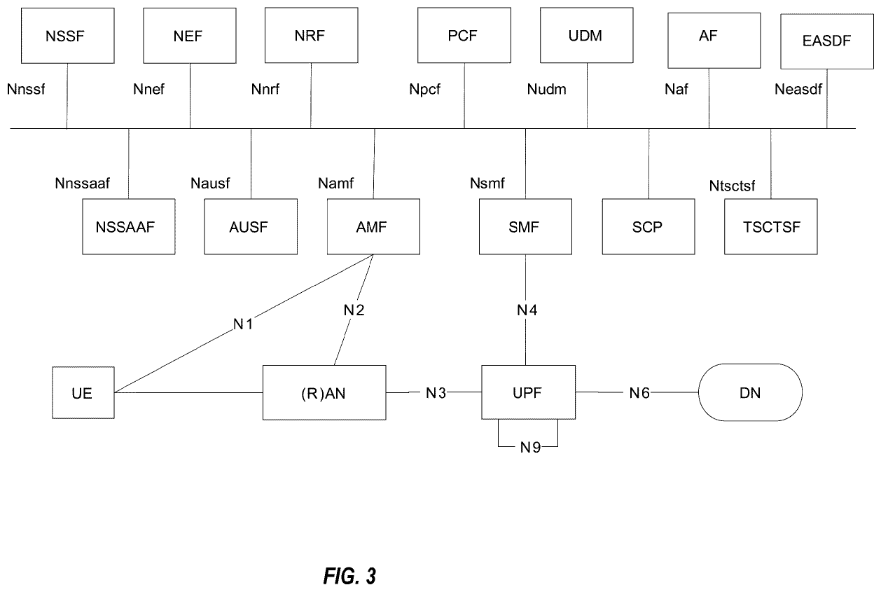

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service-based interfaces are indicated by the letter “N” followed by the name of the NF, e.g. Namf for the service based interface of the AMF 200 and Nsmf for the service based interface of the SMF 208, etc. However, it should be clarified that all NFs depicted in FIG. 2 can interact with the NEF and the NRF of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE even using multiple access technologies is basically connected to a single AMF because the AMF 200 is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support QoS. Based on the information, the PCF determines policies about mobility and session management to make the AMF 200 and SMF operate properly. The AUSF supports authentication function for UEs or similar and thus stores data for authentication of UEs or similar while the UDM 206 stores subscription data of the UE. The Data Network (DN), not part of the 5GC network, provides Internet access or operator services and similar. The TSCTSF 216 offers a number of services via the Ntsctsf API, mainly Ntsctsf_TimeSynchronization providing time synchronization service based on (g) PTP or 5G access stratum time distribution method, and allows the NF consumer to subscribe for the UE and 5G Core (5GC) capabilities for (g) PTP or 5G access stratum based time synchronization service, as well as allows the NF consumer to configure the UEs and the 5GC for the (g) PTP based time synchronization service. TSCTSF 216 also supports Ntsctsf_ASTI service that provides support Ntscfor time synchronization service based on 5G access stratum time distribution method as described in clause 5.27.1.8 of 3GPP TS 23.501 V. 17.6.0 (included herein by reference) and allows the NF consumer to configure the 5G Core and RAN for 5G access stratum based time synchronization service for the UEs. An AF can access the services directly through the Ntsctsf API or via the NEF using the Nnef API.

An NF may be implemented either as a network element on a dedicated hardware, as a software instance running on a dedicated hardware, or as a virtualized function instantiated on an appropriate platform, e.g., a cloud infrastructure.

Now, the description turns to some particular embodiments of the present disclosure. There currently exist certain challenge(s). The current solutions do not describe signaling support for providing NG-RAN time synchronization capability information from gNB to CN. Therefore, a CN is not actually aware about time synchronization capabilities (and time accuracy in particular) of a gNB.

Solutions are needed for situation including:
a. a gNB that does not support time synchronization status reporting or
b. a gNB that is not able to provide any of the information elements specified by the “clock quality metrics” agreed between the 5G network operator and the client network operator, or
c. when a gNB is not able to provide certain time accuracy as a service.

The feature is optional and therefore not all gNBs can be mandated to provide the support, similar to UEs where it has been agreed in 3GPP that this feature does not apply for pre-Rel18 UEs as described in 3GPP TR 23.700-25 V.18.0.0.

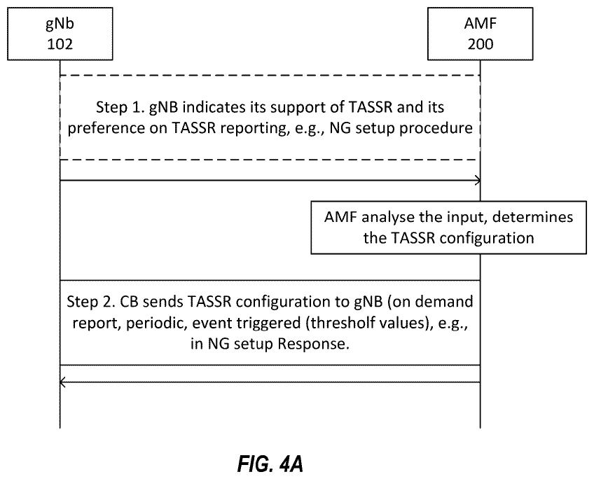

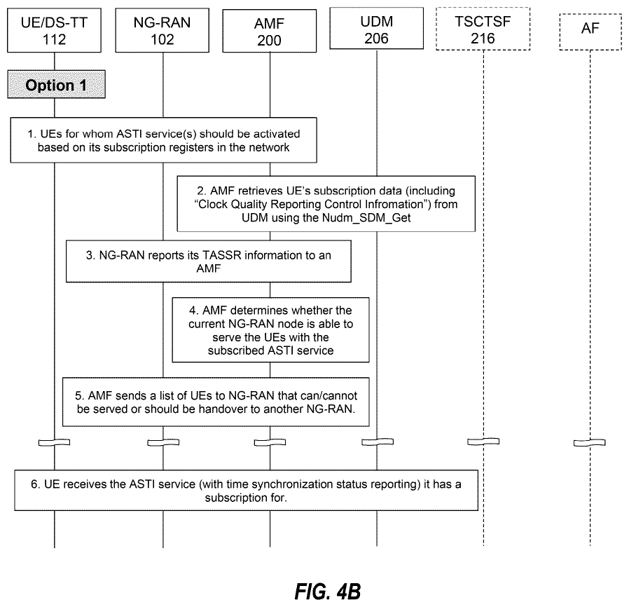

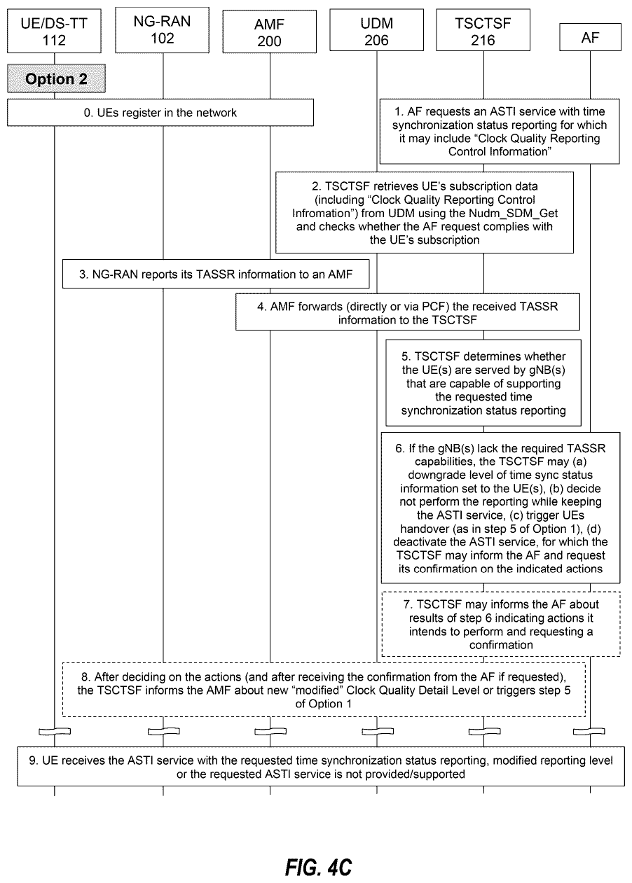

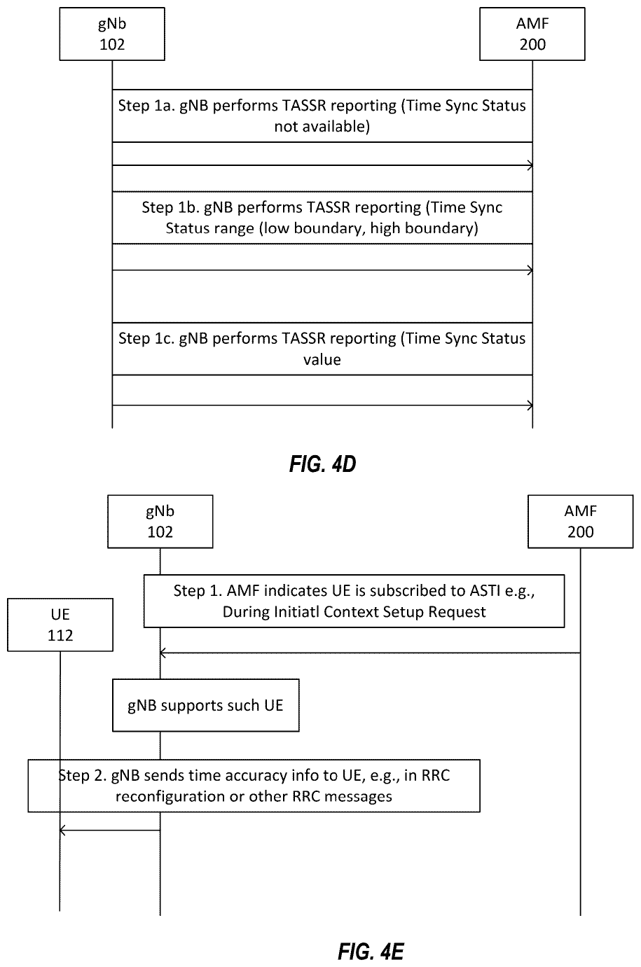

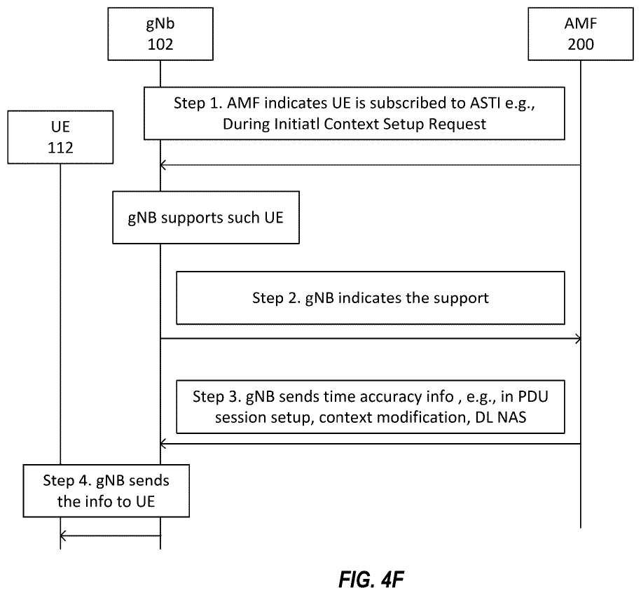

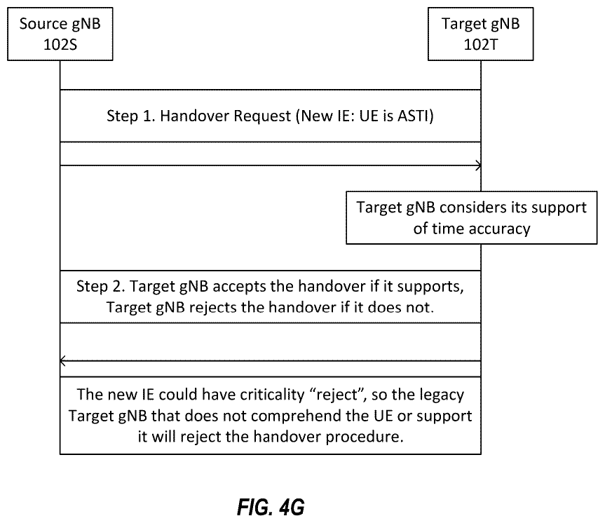

FIG. 4A is a flow diagram illustrating how Time Accuracy/Synchronization status reporting (TASSR) is configured in the NG-RAN/gNB 102 in accordance with one or more embodiment.

At step 1 of FIG. 4A, NG-RAN/gNB 102 may indicate to the CN (AMF 200 or SMF, embodiments herein are described using AMF, but may not limited thereto) over NG-AP its support capability of time accuracy/synchronization status (TASSR) reporting or how it can perform the TASSR reporting. The NG-RAN/gNB 102 may indicate its support for TASSR and optionally its preference for TASSR reporting in an NG Setup request message. However other appropriate NG-AP messages could be used. The CN (AMF) determines the TASSR configuration based on different input that comprises NG-RAN/gNB capability, UE subscription and/or O&M information. At step 2 of FIG. 4A, the CN (AMF) sends to gNB 102 the TASSR configuration indicating how the TASSR should be performed (e.g., on demand reporting, periodic, event triggered such as based on threshold values. The CN (AMF) may provide the TASSR configuration in an NG setup response message as part of NG setup procedure. Alternatively other NG-AP procedures could be used. Based on the request from the CN and NG-RAN/gNB capabilities, the NG-RAN/gNB 102 performs TASSR. Additionally, a NG-RAN/gNB 102 may indicate its support for certain slices (based on the time accuracy ranges it supports, for instance).

The steps in FIG. 4A may not follow the specific order described. For example, AMF 200 could trigger the reporting request (i.e., without a request from the NG-RAN/gNB) and the NG-RAN/gNB 102 provides feedback as in step 1. In this case, other appropriate NG-AP messages or a new procedure could be used to implement the solution.

FIGS. 4B and 4C describe two options, (option 1: subscription based, and option 2: AF request based) for CN behaviour upon reporting by the NG/RAN/gNB 102 of the time synchronization status in accordance with some embodiments.

FIG. 4B, illustrating option 1 (subscription based) is now described in details:
Step 1: One or more UEs register to the core network. As part of the registration, the Access Stratum Time Synchronization (ASTI) services should be activated based on the one or more UEs subscriptions. The details of registration are omitted as they are described in 3GPP TS 23.502 V.18.0.0.
Step 2. As part of the registration procedure, the AMF 200 obtains from the UDM 206 the one or more UEs subscription data. The subscription data include Clock Quality Reporting Control Information. The one or more UEs may be individually identified or may be identified by a group identifier.

Step 3. The NG-RAN/gNB 102 reports is TASSR information to the AMF 200 in the core network. The NG-RAN/gNB 102 may have few options to report the time synchronization status (TASSR report) to the core network (CN) as illustrated in FIG. 4D, the options comprise for e.g. indicating that the information is not available, or provide a value range for time accuracy it can support (e.g., 100 ns-250 ns, 500 ns-900 ns, etc.), or provide a specific value for each/some of the metrics. If some of the metrics, which needs to be reported, are not available at NG-RAN node (due to implementation limitation etc.), the NG-RAN node can report either that this metrics is “not available” while reporting other metrics that are available, or don't report anything at all.
Step 4. Upon the reception of the information from the NG-RAN/gNB, the CN/AMF 200 may perform the following actions for option 1, i.e., when the ASTI service is activated based on UE's subscription (i.e. without AF request). The CN (AMF) determines whether the current NG-RAN/gNB 102 is able to server the one or more UEs with the subscribed ASTI service. If the determination is positive, the CN (AMF) proceeds to step 5, else it stops.
Step 5. The CN (AMF) sends to the NG-RAN the identity (identities) of the one or more UEs that can or cannot be served or should be handed over to another NG-RAN/gNB 102 based on the status of the subscription to the ASTI service for the one or more UEs.
Step 6. Each of the one or more UEs receive the ASTI service (with time synchronization status reporting) it has subscription for.

It is to be noted that the procedure in FIG. 4B can be performed for a group of UE or for one UE. It is to be noted that step 5 may be triggered by the AMF 200 if it receives a change to the subscription to the ASTI service for any one of the one or more UE 112 that was previously indicated to the NG-RAN/gNB.

The actual messages used between the CN and the NG-RAN/gNB 102 node may be any suitable NG-AP messages or new messages can be used.

FIG. 4C, illustrating option 2 (AF requested based) is now described in details:
Step 0. One or more UEs register with the core network. The one or more UEs may or may not establish a PDU session.
Step 1. An AF sends a request towards the TSCTSF 216 (optionally via a network exposure function, NEF, not shown in the figure) to request ASTI service with time synchronization status reporting and may include “Clock Quality Reporting Control Information”.
Step 2. The TSCTSFF obtains from the UDM 206 the one or more UEs subscription data. The subscription data include Clock Quality Reporting Control Information. The TSCTSF 216 also may check whether the AF request complies with the UE's subscription. The AF may identify an individual UE, or one or more UEs via a group identifier or a list of array of UE identifiers.
Step 3. The one or more NG-RAN/gNBs reports is TASSR information to an AMF 200 or one or more AMFs in the core network. The AMF 200 corresponds to the AMF 200 from which the gNB 102 received reporting configuration information (FIG. 4A) and to which the one or more UEs registered at step 0. The NG-RAN/gNB 102 may have few options to report the time synchronization status (TASSR report) to the core network (CN) as illustrated in FIG. 4D, the options comprise for e.g. indicating that the information is not available, or provide a value range for time accuracy it can support (e.g., 100 ns-250 ns, 500 ns-900 ns, etc.), or provide a specific value for each/some of the metrics.
Step 4. Upon the reception of the information from the NG-RAN/gNB, the CN/AMF 200 forwards (directly or via a PCF) the received TASSR information to the TSCTSF 216 as reported by the NG-RAN/gNB.
Step 5. The TSCTSF 216 determines whether the one or more UEs are served by NG-RAN/gNB(s) that are capable of supporting the requested time synchronization status reporting.
Step 6. If the NG-RAN/gNB(s) lack the required TASSR capabilities, the TSCTSF 216 may
   (a) downgrade level of time sync status information set to the UE(s),
   (b) decide not to perform the reporting while keeping the ASTI service,
   (c) trigger UEs handover (as in step 5 of Option 1),
   (d) deactivate the ASTI service.
Step 7. (optional and conditional to step 6) TSCTSF 216 may inform the AF of the result of step 6 and indicate the action taken by the TSCTSF. It may in addition request confirmation by the AF on the indicated actions.
Step 8. (optional and conditional to step 6) After deciding on the actions (and optionally after receiving the confirmation from the AF when requested), the TSCTSF 216 either informs the AMF 200 (directly or via the PCF) about new “modified” Clock Quality Detail Level or the TSCTSF 216 triggers at the AMF 200 step 5 of FIG. 4B (option 1) above.
Step 9. Each of the one or more UEs receive the ASTI service with the requested time synchronization status reporting, modified reporting level or the requested ASTI service is not provided/supported.

The messages used between the CN and the NG-RAN/gNB 102 node may be any suitable NG-AP messages or new messages can be used.

FIG. 4D illustrates the different TASSR reporting options by the NG-RAN/gNB 102 to the core network. As indicated in step 3 of FIGS. 4B and 4C, the NG-RAN/gNB 102 may have few options to report the time synchronization status (TASSR report) to the core network (CN), the options comprise either
step 1a. NG-RAN/gNB 102 performing TASSR reporting indicating that time sync status is not available, or
step 1b. NG-RAN/gNB 102 performing TASSR reporting indicating time sync status value range for time accuracy with low and high boundary (e.g., 100 ns-250 ns, 500 ns-900 ns, etc.), or
step 1c. NG-RAN/gNB 102 performing TASSR reporting and provides specific time sync status value for each/some of the metrics.

The following table illustrates example of what NG-RAN node can indicate to the AMF 200 in the report:

Information elements contained in NG-RAN or
UPF timing synchronization status information

| Information Name | Description | Category |
|---|---|---|
| Synchronization | Indicates the state of the node | Optional |
| state | synchronization, represented | |
| | by the values “Locked”, | |
| | “Holdover”, or “Freerun” | |
| | (NOTE 1). | |
| Synchronization | Traceable to UTC | Optional |
| performance | Traceable to GNSS | |
| | Frequency stability | |
| Clock quality | clock accuracy | Optional |
| Time source | Describes the primary source | Optional |
| | the node is currently using, | |
| | represented by the values | |
| | “SyncE”, “PTP”, “GNSS”, | |
| | “atomic clock”, “terrestrial | |
| | radio”, “serial time code”, | |
| | “NTP”, “hand set”, “other”. | |

(NOTE 1):
Information elements contained in NG-RAN depends on RAN capabilities to determine them and pending RAN WGs feedback.
NOTE 2:
Clock is in the “Locked”, “Holdover”, or “Freerun” mode, as defined in ITU-T G.810.

FIG. 4E illustrates a flow diagram of providing time accuracy information to the UE 112 in accordance with some embodiments. Note that the procedure in FIG. 4E applies to either option 1 or 2 described in FIGS. 4B and 4C. For option 2, although FIG. 4E shows AMF 200 only, it will be understood that the signalling from the AMF 200 may be triggered by the TSCTSF.
Step 1. the CN (AMF) signals to the NG-RAN/gNB 102 the one or more UEs subscribed to ASTI service and includes time accuracy information. The CN (AMF) may consider the information from the NG-RAN/gNB 102 and only setup UE(s) at NG-RAN/gNB 102 that support the required TASSR capabilities. The CN (AMF) may signal the NG-RAN/gNB 102 using the Initial context setup request message following the UE registration (other suitable NG-AP messages can be used as well).
Step 2. The NG-RAN/gNB 102 supports UEs with the subscribed service and sends time accuracy information (obtained from the CN (AMF) or provided by the NG-RAN/gNB) to the UE 112 using an SRB, in for example an RRC reconfiguration message or other RRC message.

FIG. 4F illustrates a flow diagram of providing time accuracy information to the UE 112 in accordance with other embodiments. Note that the procedure in FIG. 4E applies to either option 1 or 2 described in FIGS. 4B and 4C. For option 2, although FIG. 4E shows AMF 200 only, it will be understood that the signalling from the AMF 200 may be triggered by the TSCTSF.

In FIG. 4F, the CN (AMF) does not necessarily have information indicating the NG-RAN/gNB 102 supports UE 112 with ASTI service. That information is received after step 1.
Step 1. the CN (AMF) signals to the NG-RAN/gNB 102 the one or more UEs subscribed to ASTI service.
Step 2. The NG-RAN/gNB 102 indicates to the CN (AMF) if it supports or that it supports the ASTI service for the UE 112 or the support for the service may be at the NG-RAN/gNb level instead of UE level.
Step 3. When the AMF 200 receives the indication the NG-RAN/gNB 102 supports the ATIS service it sends time accuracy information to the NG-RAN/gNB 102 to be provided to the UE. The time accuracy information may be included in the NG-AP message, the NG-RAN then provides the information to the UE 112 in an RRC message. Alternatively, the time accuracy information may be included in a NAS PDU message included in an appropriate NG-AP message (e.g., DL NAS transport, context modification or the likes, the NG-RAN/gNB 102 relays the NAS PDU with the time accuracy information to the UE 112 in step 4.

FIG. 4G illustrates a flow diagram of triggering handover of a UE 112 having an active ASTI subscription from a source NG_RAN/gNB to a target NG-RAN/gNB accordance with other embodiments. Note that the procedure in FIG. 4E applies to either option 1 or 2 described in FIGS. 4B and 4C. For option 2, although FIG. 4E shows AMF 200 only, it will be understood that the signalling from the AMF 200 may be triggered by the TSCTSF.

The NG-RAN node/gNB 102 may steer UE 112 to suit the ASTI service and may use the UE ASTI information to enhance handover and dual connectivity.
Step 1. The source NG-RAN (gNB) (102S) triggers a handover request towards a target NG-RAN/gNB. The handover request indicates the handover is for a UE 112 that has ASTI subscription or a handover for a UE 112 that requires ASTI service. An information element may be included to explicitly indicate the UE 112 has an ASTI subscription or the ASTI service is required.
Step 2. The target NG-RAN/gNB (102T) determines that it supports time accuracy service and accepts the handover request. If the target NG-RAN/gNB (102T) does not support time accuracy service and the service is indicated as critical in the handover request, it rejects the handover request.

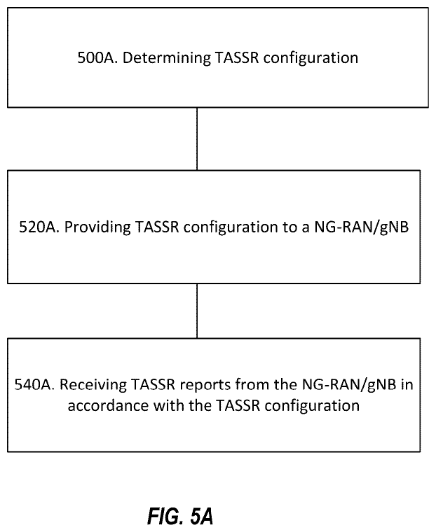

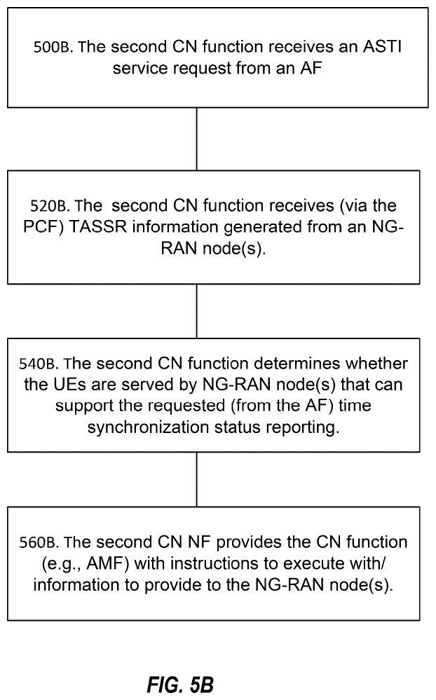

FIG. 5A is a flow chart illustrating an embodiment in a CN function (e.g., AMF).
Step 500A. The Core Network (CN) function determines the TASSR configuration indicating the TASSR should be performed by the NG-RAN node and may indicate how the reporting should be done. The reporting could be on demand, periodic or triggered by an event. For example, the CN function provides threshold values and configuration for the NG-RAN node to trigger the report. In one embodiment, the CN function determines based on O&M information that may include information of the support of time accuracy service/ASTI service in the NG-RAN nodes and the supported reporting types. Alternatively, the CN function obtains information indicating how NG-RAN node supports the TASSR, whether it can perform TASS reporting or support the ASTI service capability, and may obtain the reporting preference directly from the NG-RAN node itself. The NG-RAN node may have a very stable time accuracy (e.g. expensive oscillator) and indicates to the CN function that it only needs to report when there is a dramatic change (e.g., exceeding a x % deviation), in which case the CN function should not request a periodic reporting. Further, if NG-RAN node performs period reporting, the NG-RAN node may indicate how frequent it should be, to be considered by the CN function. In summary, the reporting preference that may be indicated by the NG-RAN node to the CN function may be on demand, periodic or event triggered.

In another embodiment, the CN function receives from the NG-RAN node that it supports ASTI UEs in some specific network slices NSSAI, The CN function uses the information to setup the UE(s) at the correct network slice.
Step 520A. The CN function provides the determined TASSR configuration to the NG-RAN node. In one embodiment the CN function provides the TASSR configuration or obtains the TASSR support and preference from the NG_RAN node using the NG Setup procedure.
Step 540A. The CN function receives TASSR report(s) from the NG-RAN node in accordance with the TASSR configuration. More specifically the CN function receives time synchronization status reports, e.g. indicating that the information is not available, or provide a value range for time accuracy it can support (e.g., 100 ns-250 ns, 500 ns-900 ns, etc.), or provide a specific value for each/some of the metrics.

In further embodiments, the CN function, receives a registration from a UE 112 and obtains the UE subscription for Access Stratum Time Synchronization (ASTI). The UE subscription comprises subscribed Clock Quality Reporting Control information, and subsequent to step 540A, the CN function determines if the NG-RAN node that provided the TASSR (reports) is able to serve the UEs with the subscribed ASTI service.

In response to the determination, in one embodiment, the CN function may inform the NG-RAN node serving the UE 112 that it can or cannot be serve the UE 112 in accordance with their subscribed ASTI service. Alternatively, the CN function may inform the NG-RAN node that a handover may be performed to a target NG-RAN node.

In another embodiment, the CN function includes the time accuracy information in the initial context setup request. Alternatively, the time accuracy information is sent by the CN function to the NG-RAN node when the specific service is setup, e.g., at PDU session setup, or context modification. In another embodiment, the CN function receives from NG-RAN node that it cannot perform TASSR, The CN function uses the information obtained from other source, e.g. OAM, to make an estimation of the time accuracy, and include it in the dedicated signalling to UE, e.g., sends the time accuracy information in a dedicated NAS message that is relayed by the NG-RAN node to the UE. In another embodiment if the NG_RAN node indicates no support for TASSR, the CN function may trigger a handover from a source NG-RAN node to a target NG-RAN node.

In another embodiment, if the CN function receives from the NG-RAN node a message that it cannot perform TASSR, the CN function may send the UPF TASSR to the NG-RAN node to assist the NG-RAN node in calculating the network time accuracy.

In another embodiment, the CN function upon reception of the TASSR report from the NG-RAN node, the CN function determines whether the requested time synchronization status reporting level can be performed at current UE's location and current NG-RAN node or it should be modified, or whether it should trigger the handover procedure etc. as described in FIGS. 4B, 4C and 4G.

FIG. 5B is a flow chart illustrating an embodiment in a second CN function (e.g., TSCTSF) (option 2)
Step 500B. The second CN function receives an ASTI service request from an AF (via the NEF, optional) that may include Clock Quality Reporting Control Information and retrieves subscription data that includes subscription lock Quality Reporting Control Information and checks the AF request complies with the UE's subscription.
Step 520B. The second CN function receives (via another function, e.g., the PCF) TASSR information generated from an NG-RAN node. More specifically the TASSR information comprises time synchronization status reports, e.g., indicating that the information is not available, or provide a value range for time accuracy it can support (e.g., 100 ns-250 ns, 500 ns-900 ns, etc.), or provide a specific value for each/some of the metrics.
Step 540B. The second CN function determines whether the UEs are served by NG-RAN node(s) that can support the requested (from the AF) time synchronization status reporting.

In some embodiments, if the second CN function determines that the NG-RAN node(s) lack the required TASSR capabilities, the second CN function may (a) downgrade level of time sync status information set to the UE(s), (b) decide not to perform the reporting while keeping the ASTI service, (c) trigger UEs handover to a target NG-RAN, (d) deactivate the ASTI service. The second CN function may inform the AF of the selected action and may request a confirmation from the AF on the indicated action(s).
Step 560B. The second CN NF provides the CN function (e.g., AMF) with instructions to execute with the NG-RAN node(s) and/or information to provide to the NG-RAN nodes. For example, the second CN function may inform about a new or modified Clock Quality detail level, which will be provided to the NG-RAN node. Alternatively, the second CN function may trigger the CN function (AMF) to inform the NG-RAN node serving the UE 112 that it can or cannot serve the UE 112 in accordance with the requested Time Accuracy/Synchronization status reporting or ASTI service request from the AF. Alternatively, the CN function (AMF) may inform the NG-RAN node that a handover may be performed to a target NG-RAN node.

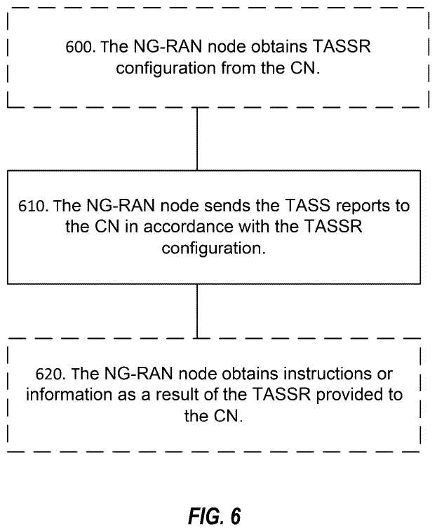

FIG. 6 is a flow chart illustrating one or more embodiment in an NG-RAN node.
Step 600. The NG-RAN node obtains TASSR configuration. In one embodiment, prior to obtaining the TASSR configuration from the CN, the NG-RAN node may indicate to the CN its support of time accuracy reporting or how it can provide the reports. More specifically
   the NG-RAN node to indicate if it supports TASSR;
   the NG-RAN node to indicate how it supports TASSR, for example, to report a rough value, to report a range (low, high) or ranges, or exact value(s).
   the NG-RAN node prefers to report per Event trigger, report when change has occurred
   the NG-RAN node prefers to report periodically, and the right periodic value proposals.
Step 610. The NG-RAN node sends the reports, TASSR to the CN in accordance with the TASSR configuration.
Step 620. The NG-RAN node may as a result of the report obtain further instructions or information as a result of the TASSR provided to the CN. More specifically, in one embodiment, when the NG-RAN node receives from the CN that the UE is subscribed for ASTI, the NG-RAN node,
   may steer the UE to a specific slicing to handle the service, or
   may steer the UE away, e.g. via handover or redirect.
In another embodiment, the NG-RAN node may store the UE ASTI information (sent by CN) in the UE context and use it to enhance handover, the handover may be instructed by the CN or initiated by the NG-RAN node, more specifically:
   the NG-RAN node may choose the right target NG-RAN node based on its support of Access Stratum based Time distribution service (ASTI) for UEs, or
   the handover target NG-RAN node may accept or reject the handover or the UE based on its support for the Access Stratum based Time distribution service
In another embodiment, the NG-RAN node may store in the UE context the UE ASTI information sent by CN and use it to enhance dual connectivity:
   If dual Connectivity is setup, the MN (Master NG-RAN node) may use the information to select the right SN (Secondary NG-RAN node)
   The SN may use this information to determine if it accepts or rejects the addition.
In another embodiment, when the NG-RAN node receives the TASSR request from the CN, the TASSR request may include a validity period indicating how long the TASSR is valid or may include validity conditions. This would prevent frequently signalling for a report or frequent signalling of the report when no change has occurred.
In another embodiment, the NG-RAN node may obtain the UE ASTI related information over the RRC layer.

One or more advantages of the embodiments presented in this specification include enabling NG-RAN nodes to report their time accuracy/synchronization status reporting (TASSR) capabilities to a core network (CN) so that the CN use this information to
(1) modify a Clock Quality Detail Level provided to a UE,
(2) trigger a handover of UEs to another gNB 102 i.e., NG-RAN node that has the required TASSR capabilities,
(3) inform the AF (if it is a requester of the ASTI service) about why the ASTI service is rejected or is about to be rejected after the confirmation, and/or
(4) decline the time synchronization status reporting due to gNB i.e., NG-RAN node limitations (e.g., due to UE's current location or the current serving gNB own limitations).

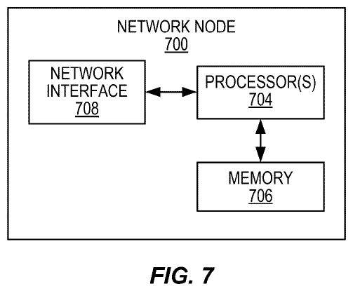

FIG. 7 is a schematic block diagram of a network node 700 according to some embodiments of the present disclosure. Optional features are represented by dashed boxes. The network node 700 may be, for example, a core network node that implements a NF (e.g., AMF 200, SMF 208, UDM 206, TSCTSF, AF, PCF) or a network node that implements all or part of the functionality of an NF (e.g., all or part of the functionality of the AMF 200, SMF 208, UDM 206, TSCTSF, AF, PCF described herein). As illustrated, the network node 700 includes a one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. The one or more processors 704 operate to provide one or more functions of the network node 700 as described herein (e.g., one or more functions of the AMF 200, SMF 208, UDM 206, TSCTSF, AF, PCF described herein). In some embodiments, the function(s) are implemented in software that is stored, e.g., in the memory 706 and executed by the one or more processors 704.

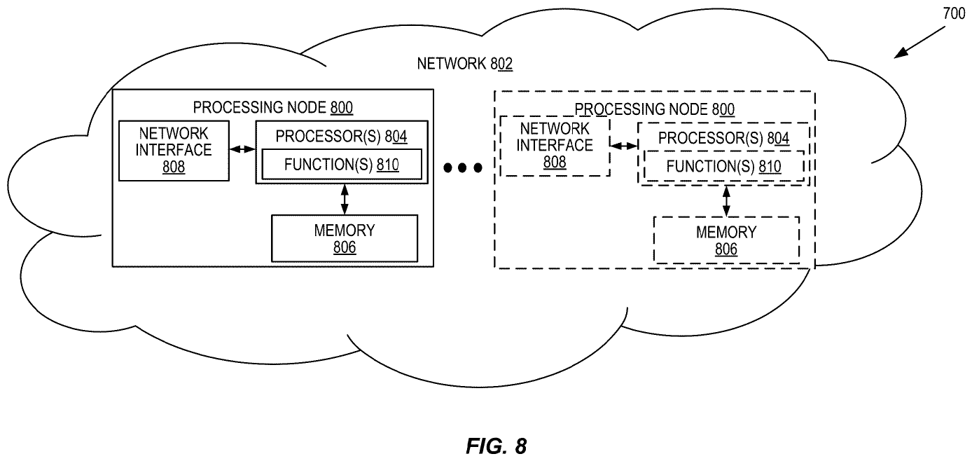

FIG. 8 is a schematic block diagram that illustrates a virtualized embodiment of the network node 700 according to some embodiments of the present disclosure. Again, optional features are represented by dashed boxes. As used herein, a “virtualized” network node is an implementation of the network node 700 in which at least a portion of the functionality of the network node 700 is implemented as a virtual component(s) (e.g., via a virtual machine(s) executing on a physical processing node(s) in a network(s)). As illustrated, in this example, the network node 700 includes one or more processing nodes 800 coupled to or included as part of a network(s) 802. Each processing node 800 includes one or more processors 804 (e.g., CPUs, ASICs, FPGAs, and/or the like), memory 806, and a network interface 808. In this example, functions 810 of the network node 700 described herein (e.g., one or more functions of the AMF 200, SMF 208, UDM 206, TSCTSF, AF, PCF described herein) are implemented at the one or more processing nodes 800 or distributed across the two or more processing nodes 800 in any desired manner. In some particular embodiments, some or all of the functions 810 of the network node 700 described herein are implemented as virtual components executed by one or more virtual machines implemented in a virtual environment(s) hosted by the processing node(s) 800.

In some embodiments, a computer program including instructions which, when executed by at least one processor, causes the at least one processor to carry out the functionality of the network node 700 or a node (e.g., a processing node 800) implementing one or more of the functions 810 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

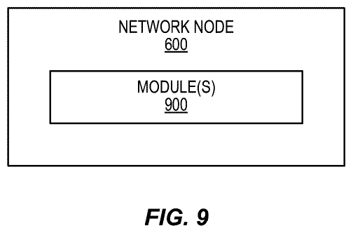

FIG. 9 is a schematic block diagram of the network node 700 according to some other embodiments of the present disclosure. The network node 700 includes one or more modules 900, each of which is implemented in software. The module(s) 900 provide the functionality of the network node 700 described herein. This discussion is equally applicable to the processing node 800 of FIG. 8 where the modules 800 may be implemented at one of the processing nodes 800 or distributed across multiple processing nodes 800.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

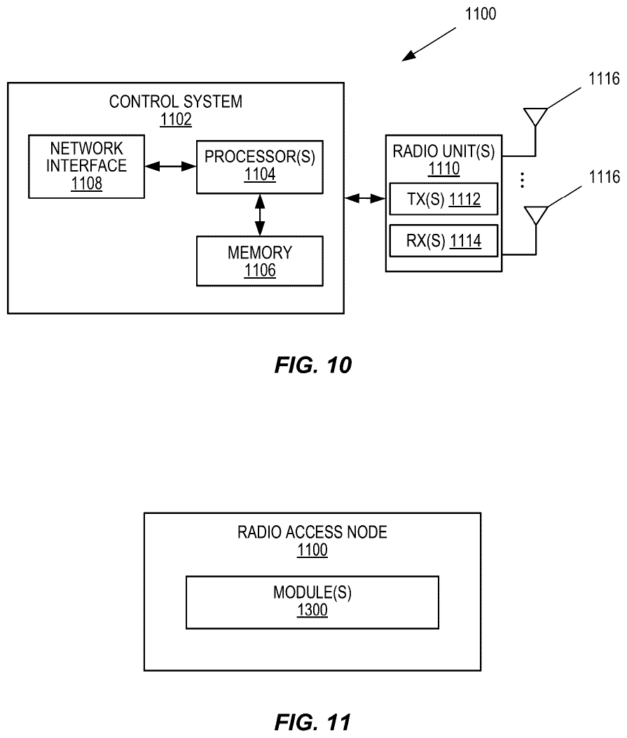

FIG. 10 is a schematic block diagram of a radio access node 1100 according to some embodiments of the present disclosure. The radio access node 1100 may be, for example, a base station 302 or 306. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 includes one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

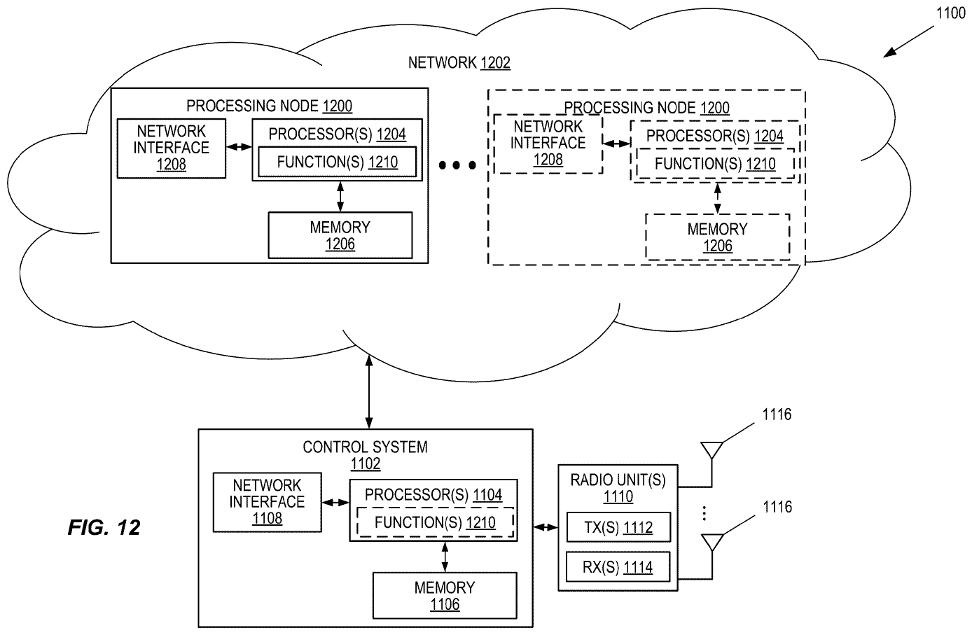

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 includes the control system 1102 that includes the one or more processors 1104 (e.g., CPUs, ASICS, FPGAs, and/or the like), the memory 1106, and the network interface 1108 and the one or more radio units 1110 that each includes the one or more transmitters 1112 and the one or more receivers 1114 coupled to the one or more antennas 1116, as described above. The control system 1102 is connected to the radio unit(s) 1110 via, for example, an optical cable or the like. The control system 1102 is connected to one or more processing nodes 1200 coupled to or included as part of a network(s) 1202 via the network interface 1108. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the control system 1102 and the one or more processing nodes 1200 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

The following are few examples of non-limiting claim-like embodiments.

### Group A: AMF

Embodiment 1. A method comprising:
determining Time Accuracy/Synchronization status reporting (TASSR) configuration;
providing the TASSR configuration to a NG-RAN node; and
receiving Time Accuracy/Synchronization status TASS reports from the NG-RAN node in accordance with the TASSR configuration.

Embodiment 2. The method of embodiment 1 further comprising in response to the received TASS reports, providing to the NG-RAN node information indicating that the NG-RAN node can or cannot serve a User Equipment in accordance with Access Stratum Time Synchronization (ASTI) subscription of the UE.

Embodiment 3. The method of embodiment 1 further comprising in response to the received TASS reports, instructing the NG-RAN node to handover the UE to a target NG-RAN node.

### Group B: TSCTSF

Embodiment 1. A method comprising:
receiving for one or more UEs Time Accuracy/Synchronization status reporting (TASSR) request or Access Stratum Time Synchronization (ASTI) service request originated from an Application Function (AF);
receiving Time Accuracy/Synchronization status TASS reports generated by NG-RAN node(s) for the one or more UEs;
determining based on the TASS reports whether the one or more UEs are served by NG-RAN nodes that support the requested time synchronization status reporting from the AF; and
providing instructions to be applied toward the NG-RAN node in accordance with the determination.

Embodiment 2. The method of embodiment 4 wherein the instruction comprises informing a second network function (e.g., AMF) about a new or modified Clock Quality Detail Level.

Embodiment 3. The method of embodiment 4 wherein the instruction comprises providing to the NG-RAN node information indicating that the NG-RAN node can or cannot serve a User Equipment in accordance with the requested Time Accuracy/Synchronization status reporting/ASTI service request.

Embodiment 4. The method of embodiment 4 wherein based on the TASS report, determine not to perform the reporting while keeping the ASTI service.

Embodiment 5. The method of embodiment 4 wherein based on the TASS report, determine instructing that a handover to a target NG-RAN node be performed from the NG-RAN node that provided the TASS reports for the one or more UEs.

### Group C: gNB

Embodiment 1. A method comprising:
obtaining Time Accuracy/Synchronization status reporting (TASSR) configuration;
sending Time Accuracy/Synchronization status TASS reports to the Core Network (CN) in accordance with the TASSR configuration.
receiving instruction to be applied as a result of the provided TASS reports.

Embodiment 2. The method of embodiment 9 wherein the instruction comprises indicating whether the NG-RAN node can or cannot serve a User Equipment in accordance with requested Time Accuracy/Synchronization status reporting or UE subscription.

Embodiment 3. The method of embodiment 9 wherein the instruction comprises performing a handover to a target NG-RAN node.

Embodiment 4. The method of embodiment 9 wherein the method further comprises sending to the CN capability information indicating the NG_RAN node is able to perform TSSA reporting.

Embodiment 5. The method of embodiment 9 wherein the method further comprises sending to the CN the TSSA reporting preferences.

Embodiment 6. A network node adapted to perform the method of any of embodiments 1 to 8.

Embodiment 7. A base station node adapted to perform the method of any of embodiments 9 to 13.

Embodiment 8. A non-transitory computer-readable storage medium that includes executable instructions that when executed by a processor cause the processor to perform the method of any of embodiments 1 to 8.

Embodiment 9. A non-transitory computer-readable storage medium that includes executable instructions that when executed by a processor cause the processor to perform the method of any of embodiments 9 to 13.

The following are3GPP proposals based on one or more if the enclosed embodiments and include additional details to the embodiments described in this disclosure.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
ASIC Application Specific Integrated Circuit
ASTI Access Stratum based Time Distribution service
AUSF Authentication Server Function
CPU Central Processing Unit
DN Data Network
DSP Digital Signal Processor
eNB Enhanced or Evolved Node B
FPGA Field Programmable Gate Array
gNB New Radio Base Station
IP Internet Protocol
LTE Long Term Evolution
MN Master NG-RAN node
NEF Network Exposure Function
NF Network Function
NR New Radio
NRF Network Function Repository Function
OTT Over-the-Top
PC Personal Computer
PCF Policy Control Function
PDU Packet Data Session Unit
PTP Precision Time Protocol
RAM Random Access Memory
RAN Radio Access Network
ROM Read Only Memory
RP Reception Point
RRH Remote Radio Head
RTT Round Trip Time
SN Secondary NG-RAN node
SMF Session Management Function
TASSR Time Accuracy/Synchronization Status Reporting (capabilities/information)
TSCTSF Time Sensitive Communication and Time Synchronization Function
UDM Unified Data Management
UE User Equipment
UPF User Plane Function
VPLMN Visited Public Land Mobile Network

1. A method performed by a first core network function providing access and mobility management services, the method comprising:
providing to a radio access network (RAN) node a Time Accuracy/Synchronization Status Reporting configuration to trigger Time Accuracy/synchronization Status Reporting by the RAN node; and
receiving one or more Time Accuracy/Synchronization Status reports generated by the RAN node based on the Time Accuracy/Synchronization Status Reporting configuration.

2. The method of claim 1 wherein the one or more Time Accuracy/Synchronization Status reports include one or more of clock accuracy and synchronization state.

3. The method of claim 1 further comprising in response to the received Time Accuracy/Synchronization Status reports, providing to the RAN node information indicating whether the RAN node can or cannot serve a User Equipment (UE) in accordance with Access Stratum Time Synchronization (ASTI) subscription obtained for the UE.

4. The method of claim 1 further comprising in response to the received Time Accuracy/Synchronization Status reports, instructing the RAN node to handover the UE to a target RAN node.

5. The method of claim 1 wherein the step of providing to the RAN node the Time Accuracy/Synchronization Status Reporting configuration to trigger Time Accuracy/Synchronization Status Reporting by the RAN node is triggered by a request from a second network function.

6. The method of claim 5 wherein the Time Accuracy/Synchronization Status reports obtained from the RAN node are provided to the second network function.

7. A method performed by a second core network function providing time synchronization service, the method comprising:
receiving for one or more UEs Time Accuracy/Synchronization Status reporting (TASSR) request or Access Stratum Time Synchronization (ASTI) service request originated from an Application Function (AF);
receiving from a first core network function Time Accuracy/Synchronization Status report generated by a Radio Access Network (RAN) node for the one or more UEs;
determining based on the Time Accuracy/Synchronization Status report whether the one or more UEs are served by the RAN node that supports the requested time synchronization status reporting from the AF; and
providing instructions to be applied toward the RAN node in accordance with the determination.

8. The method of claim 7 wherein the instructions comprise informing the first network function about a new or modified Clock Quality Detail Level.

9. The method of claim 7 wherein the instructions comprise providing for the RAN node information indicating that the RAN node can or cannot serve a User Equipment in accordance with the requested Time Accuracy/Synchronization status reporting or the ASTI service request.

10. The method of claim 7 wherein based on the Time Accuracy/Synchronization Status report, instructing that a handover to a target RAN node is to be performed from the RAN node that provided the Time Accuracy/Synchronization Status reports for the one or more UEs.

11. A method performed by a Radio Access Network (RAN) node, the method comprising:
obtaining Time Accuracy/Synchronization Status reporting configuration from a first core network function of a core network;
sending Time Accuracy/Synchronization status reports to the first core network function in accordance with the Time Accuracy/Synchronization Status reporting configuration;
wherein the Time Accuracy/Synchronization Status reports include one or more of time accuracy and time synchronization status.

12. The method of claim 11 further comprising receiving instruction to be applied as a result of the provided Time Accuracy/Synchronization Status reports.

13. The method of claim 12 wherein the instruction comprises information indicating whether the RAN node can or cannot serve a User Equipment (UE) in accordance with a requested Access Stratum Time Synchronization (ASTI) subscription from another network function or a UE subscription.

14. The method of claim 12 wherein the instruction comprises performing a handover to a target RAN node.

15. The method of claim 11 wherein the method further comprises sending to the core network a capability information indicating whether the RAN node is able to perform Time Accuracy/Synchronization Status reporting.

16. The method of claim 11 wherein the method further comprises sending to the core network Time Accuracy/Synchronization Status reporting preferences.

17-20. (canceled)

21. A non-transitory computer-readable storage medium that includes executable instructions that when executed by a processor cause the processor to perform the method of claim 1.

22. A non-transitory computer-readable storage medium that includes executable instructions that when executed by a processor cause the processor to perform the method of claim 7.

23. A non-transitory computer-readable storage medium that includes executable instructions that when executed by a processor cause the processor to perform the method of claim 11.
